(19) United States
(12) Patent Application Publication
(10) Pub. No.: US 2002/0141387 A1
(43) Pub. Date: Oct. 3, 2002

(54) System, method and computer program product for delivery of internet services from a central system to multiple internet service providers at guaranteed service levels

(76) Inventor: David Orshan, Aventura, FL (US)

Correspondence Address: C. Douglas McDonald, Esq., Carlton Fields, et al., P.O. Box 3239, Tampa, FL, 33601-3239, US

(21) Appl. No.: 09/825,904

(22) Filed: Apr. 3, 2001

(51) Int. Cl. H04L 12/66

(52) U.S. Cl. 370/352; 370/401

(57) ABSTRACT

A system, method and computer program product are disclosed for delivering content utilizing a guaranteed bandwidth network service. Content is stored in a central server. Requests are received at the central server from a user at a computer terminal utilizing a virtual private network. The requests are routed from a module positioned within one thousand (1000) feet from the computer terminal and which is capable of sending the requests to other destinations utilizing the Internet.

### FIELD OF THE INVENTION

This invention relates to networks, and more particularly, relates to network provider frameworks.

### BACKGROUND OF THE INVENTION

Explosive growth of the internet and the worldwide web is driving a need for increased communication data rates. In the corporate world, the need for high-speed access or data rates is met by dedicated high-speed links (such as, T1/E1 frame relays or OC1 ATM systems) from the company to an internet access provider. Users in the company typically utilize a local area network (LAN) to gain access to an internet access router that is coupled to the high-speed link. Unfortunately, home users of the internet do not often have access to a high-speed link and must rely on a standard analog or plain old telephone service (POTS) subscriber line.

The need for high-speed access to the home is ever increasing due to the increased popularity of telecommuting and the availability of information, data, programs, entertainment, and other computer applications on the worldwide web and the internet. For example, designers of web technology are constantly developing new ways to provide sensory experiences, including audio and video, to users of the web (web surfers). Higher-speed modems are required so the home user can fully interact with incoming web and communication technologies.

Although designers of modems are continuously attempting to increase data rates, analog or POTS line modems are presently only able to reach data rates of up to 56 kilobits per second (Kbps). These conventional analog modems transmit and receive information on POTS subscriber lines through the public switched telephone network (PSTN). The Internet access provider is also coupled to the PSTN and transmits and receives information through the PSTN to the subscriber line.

Some home users have utilized ISDN equipment and subscriptions to obtain up to 128 Kbps access or data rates by the use of two data channels (B channels) and one control channel (D channel). ISDN equipment and subscriptions can be expensive and require a dedicated subscriber line. Neither ISDN modems nor conventional analog modems are capable of providing 256 Kbps or higher access between the home and the internet.

A variety of communication technologies are competing to provide high-speed access to the home. For example, asymmetric digital subscriber lines (ADSL), cable modems, satellite broadcast, wireless LAN's, and direct fiber connections to the home have all been suggested. Of these technologies, the asymmetric digital subscriber line can utilize the POTS subscriber line (the wire currently being utilized for POTS) between the home user (the residence) and the telephone company (the central office).

ADSL networks and protocols were developed in the early 1990's to allow telephone companies to provide video-on-demand service over the same wires which were being used to provide POTS. DSL technologies include discrete multitone (DMT), carrierless amplitude and phase modulation (CAP), high-speed DSL (VDSL), and other technologies. Although the video-on-demand market has been less than originally expected, telephone companies have recognized the potential application of ADSL technology for internet access and have begun limited offerings.

DSL technology allows telephone companies to offer high-speed internet access and also allows telephone companies to remove internet traffic from the telephone switch network. Telephone companies cannot significantly profit from internet traffic within the telephone switch network due to regulatory considerations. In contrast, the telephone company can charge a separate access fee for DSL services. The separate fee is not as restricted by regulatory considerations.

### SUMMARY OF THE INVENTION

A system, method and computer program product are disclosed for delivering content utilizing a guaranteed bandwidth network service. Content is stored in a central server. Requests are received at the central server from a user at a computer terminal utilizing a virtual private network. The requests are routed from a module positioned within one thousand (1000) feet from the computer terminal and which is capable of sending the requests to other destinations utilizing the Internet.

In an aspect of the present invention, the module may include a multiplexer. In such an aspect, the multiplexer may includes a digital subscriber line access multiplexer (DSLAM). In another aspect, the requests received by the central server may be preregistered. In a further aspect, the requests received by the central server may be tracked for billing purposes. In an additional aspect, the content may include video.

### BRIEF DESCRIPTION OF THE DRAWINGS

FIG. 1 is a schematic diagram representing a standard digital subscriber line (DSL) architecture;

FIG. 2 is a schematic diagram representing a DSL architecture of ISP franchise framework in accordance with an embodiment of the present invention;

FIG. 3 is a schematic diagram illustrating a backbone configure of the ISP franchise framework in accordance with an embodiment of the present invention;

FIG. 4 is a schematic illustration of a subscriber process in the DSL architecture of ISP franchise framework in accordance with an embodiment of the present invention;

FIG. 5 illustrates a process flow for a subscriber process in ISP franchise framework in accordance with an embodiment of the present invention;

FIG. 6 is a schematic diagram of a Locally Empowered Access Provider/CLEC partnership in accordance with an embodiment of the present invention;

FIG. 7 is a flowchart of a process for delivering guaranteed bandwidth network service in accordance with an embodiment of the present invention;

FIG. 8 is a flowchart of a process for billing for guaranteed bandwidth network service in accordance with an embodiment of the present invention;

FIG. 9 is a flowchart of a process for delivering content utilizing a guaranteed bandwidth network service in accordance with an embodiment of the present invention; and

FIG. 10 is a schematic diagram of a representative hardware environment in accordance with an embodiment of the present invention.

### DETAILED DESCRIPTION

In general, embodiments of the present invention provide a framework for providing an Internet Service Provider (ISP) franchise framework by an Independent Locally Empowered Access Provider. The ISP franchise framework is capable of converting existing operating ISPs to a franchise business platform that may offer cost savings to the franchisees through national purchasing agreements, as well as a provide dynamic operating platform that integrates billing, customer service and order processing for the franchisees.

In 2001, there are approximately 7,000

ISP's in the United States providing Internet access service to the individual consumer and business markets. The number of ISPs is expected to grow at a rate of 13.6% per year to approximately 12,000 ISP's by 2004. The Internet subscriber base in the United States is also expected increase from 46 million to 74 million by 2004. In general, the ISP market is segmented into National ISP's and independent local ISP's of which there are over 5,000. Fragmentation within the local ISP segment has produced an amalgamation opportunity that the Independent Locally Empowered Access Provider may capture through a franchise conversion of existing local ISP's.

In an effort to maintain their independence and market shares, local ISPs are confronted with the following issues: cash flow and financing; low economies of scale; lack of integrated billing solutions; national competition, increasing technology costs; and high customer turnover rates.

In accordance with an embodiment of the present invention, the ISP franchise framework conversion of independently owned ISPs into a national franchise organization may deliver benefits such as: national purchasing power providing economies of scales and savings; a national marketing program funded by the franchisees for the purpose of branding and advertising promotion; an integrated operating platform for supporting integrated billing, customer service and provisioning not available to local ISP's; a secure and redundant network operations center for helping to ensure a high quality of service and continuous management of all network components and systems; products and services delivered via strategic partnerships including dial up access, web hosting, dedicated bandwidth and equipment purchases; and franchise-wide-employee training to help build and develop the local ISP's sales and marketing efforts.

In one embodiment of the present invention, franchisees in the ISP franchise framework may pay a contractual monthly royalty fee to the Independent Locally Empowered Access Provider such as, for example a monthly royalty fee 6.5% of the franchisee's revenue. Also, each franchisee may pay a one-time franchise fee to the Independent Locally Empowered Access Provider.

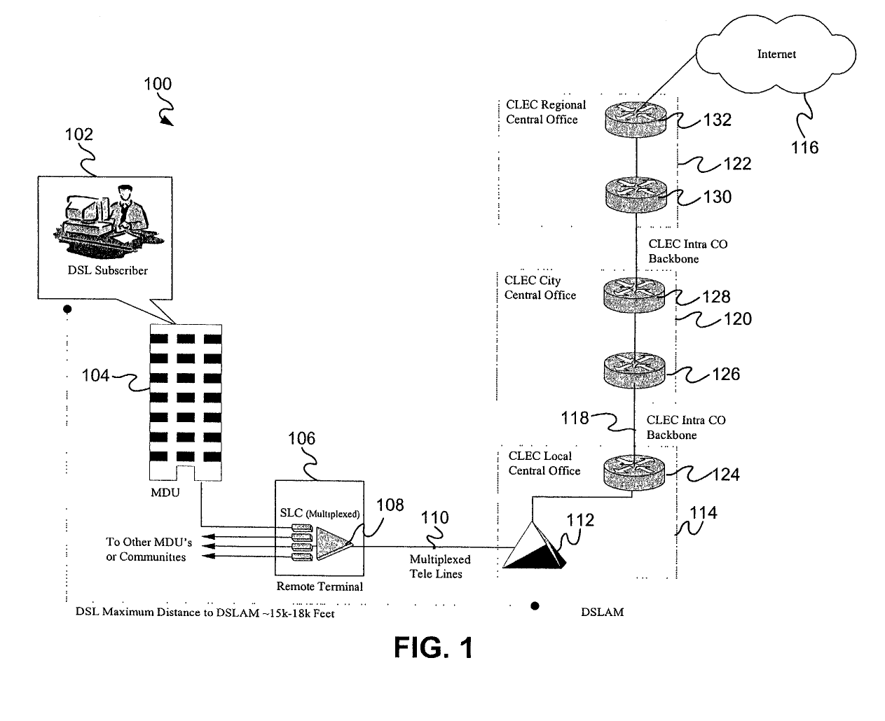

FIG. 1 is a schematic diagram representing a standard digital subscriber line (DSL) architecture 100. In this architecture, one or more DSL subscribers 102 are located in a multi-dwelling unit (MDU) 104 such as an apartment, condo, hotel, or other multi-use facility. The DSL subscribers are connected to a remote terminal (SLC) 106 of a competitive local exchange carrier (CLEC) that amalgamates telephone lines 108 from a given area of coverage into a single location where the lines are connected to the telephone company's high speed connectivity 110 to a digital subscriber line access multiplexer (DSLAM) 112 located at a local central office 114 of the CLEC. The DSLAM is a device that allows the separation of voice and data on the same telephone wires for the end user.

As illustrated in FIG. 1, a typical maximum distance between the DSL subscribers line and the DSLAM 112 is approximately 15000-18000 feet. From the CLEC local central office 114, the DSL subscriber is connected to the Internet 116 via an intra-company backbone 118 which connects various CLEC locations/offices 120, 122 via routers 124, 126, 128, 130, 132. For purposes of clarity, a Local Exchange Carrier (LEC) is a local telephone carrier i.e.: Bell South, Pac Bell, etc. CLEC's are companies that compete with the incumbent LEC for local telephone service as provided for in the 1996 Telecommunications ACT. The central offices are locations where CLEC's provide the switching capability for voice and data communications. They are also the locations where long distance companies and current DSL carriers may co-locate their equipment to gain access to that CO's area of coverage.

Some problems with the architecture 100 set forth in FIG. 1 may include: distance limitations between DSL modem and DSLAM (located at CO) increase installation problems and time; typical DSL oversell ratio at internet “on-ramp” are 1000-2000/1; DSL competitors typically have to install DSLAM's at the CLEC CO's; applications, content or services delivered to the subscriber typically have to take an unknown path through the Internet. This unknown path may often effect the quality and the subscriber's experience.

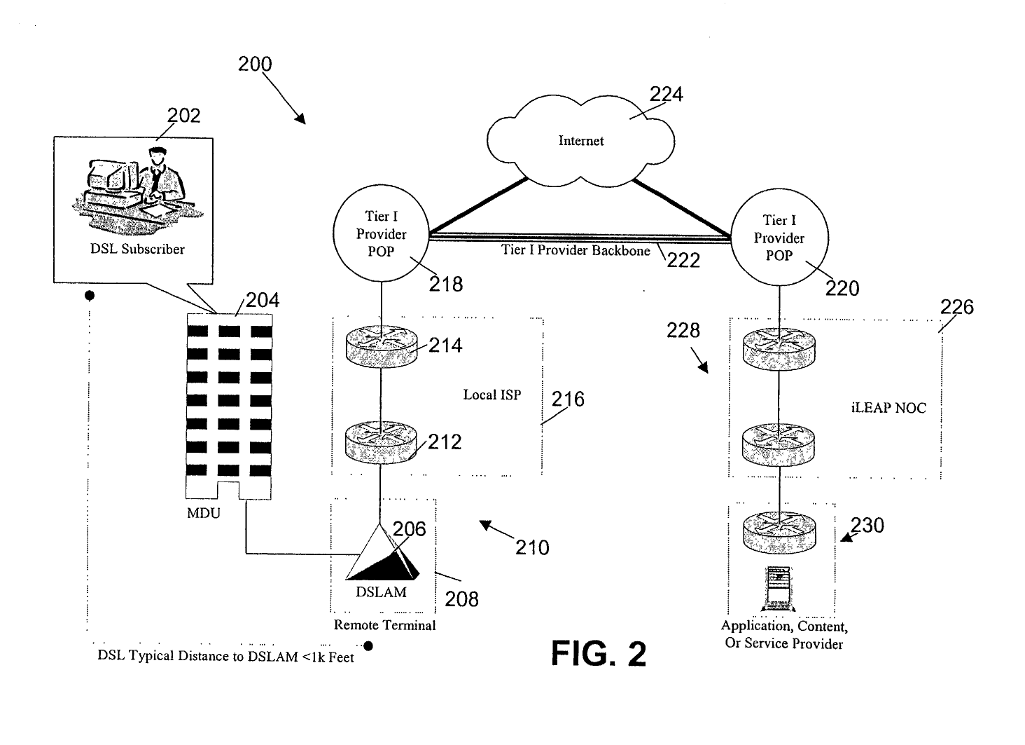

FIG. 2 is a schematic diagram representing a DSL architecture 200 of ISP franchise framework in accordance with an embodiment of the present invention. In this architecture 200, one or more DSL subscribers 202 located in a multi-dwelling unit (MDU) 204 are connected to a DSLAM 206 at a remote terminal 208 of a local ISP framework 210 which is, in turn, connected to routers 212, 214 of a local ISP 216. In accordance with one aspect of the present invention, the Local ISP may be a citywide or state wide Internet service provider. The local ISP 216 is connected to a first Tier I Provider Point of Presence (POP) 218 which is connected to a second Tier I Provider POP 220 via a high speed backbone/virtual private network (VPN) 222. For purposes of this description, Tier 1 refers to a communications carrier that has a national fiber optic backbone connecting one or more network access points for the purpose of transferring data from one location to another or to another carriers network. The POP refers to the Point Of Presence in a specific city or town where that carrier's national fiber network connects customers in that particular city to the network. The Tier one Provider Backbone is the fiber that is on a specific carriers network that is not considered the Internet but instead is a private pathway between points of presence on their network.

The Tier I Provider POP's 218, 220 may also each be connected to a wide area network such as the Internet 224. Connected to the second Tier I Provider POP 220 is a network operations center (NOC) 226 of an Independent Locally Empowered Access Provider framework 228. Connected to the Independent Locally Empowered Access Provider NOC 226 are various application, content and service servers 230 of the Independent Locally Empowered Access Provider.

In accordance with an aspect of the present invention, the DSLAM 206 may be located at the Remote Terminal or building entrance facility instead of CLEC Central Office as in the case of the traditional framework 100 set forth in FIG. 1. In this framework 200, the typical distance from the DSL modem to the DSLAM may be less than 1000 feet. This helps to substantially reduce installation time and effort. This also helps the distribution of “Self Install Kits” to be used more frequently. Oversell ratio at internet “on-ramp” maybe typically 10-15/1. The reduced oversell ratio helps the subscriber enjoy a high quality experience. Applications, services, or content delivered to the subscriber may be routed via a known path through the network as opposed to an unknown path through the internet. This may help to make the architecture 200 extremely attractive to ASP providers. Information transmitted from the NOC 226 may traverse the Tier I providers backbone using a mechanism that helps to guarantee bandwidth and latency. This mechanism may be a large VPN.

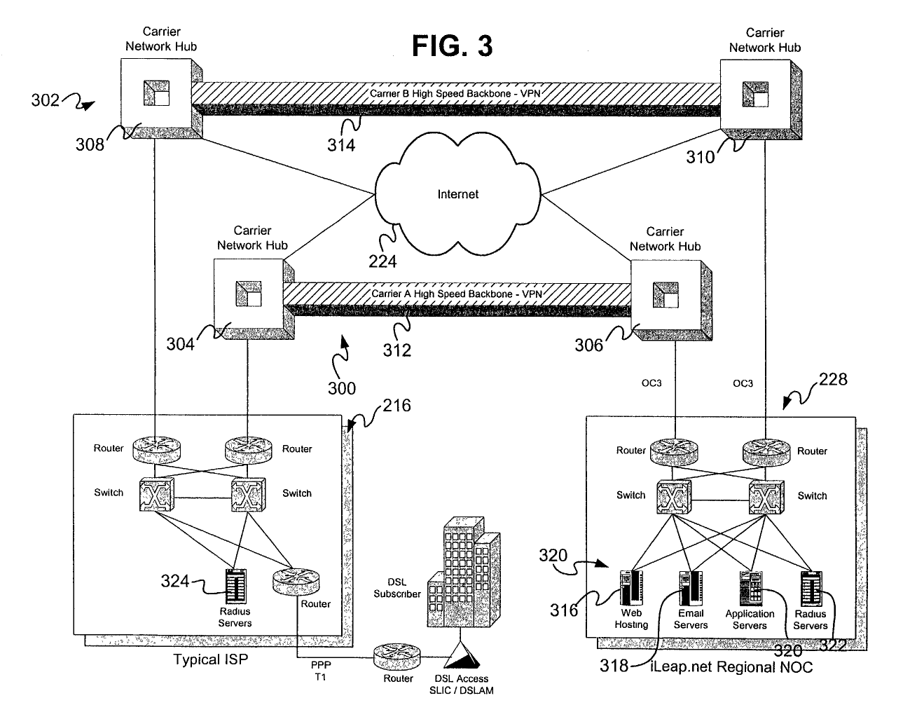

FIG. 3 is a schematic diagram illustrating a backbone configure of the ISP franchise framework in accordance with an embodiment of the present invention. In this embodiment, the ISP framework 216 and the Independent Locally Empowered Access Provider framework 228 may be connected together via a pair of Tier I Provider POP backbones 300, 302 each having a pair of Tier I Provider POP's 304, 306, 308, 310 connected together via a corresponding high speed backbone/VPN 312, 314 and the Internet 224. As illustrated in FIG. 3, the various application, content and service servers 230 may include web hosting servers 316, email servers 318, application servers 320 and radius servers 322. The ISP 216 may also include a radius server 324 as well.

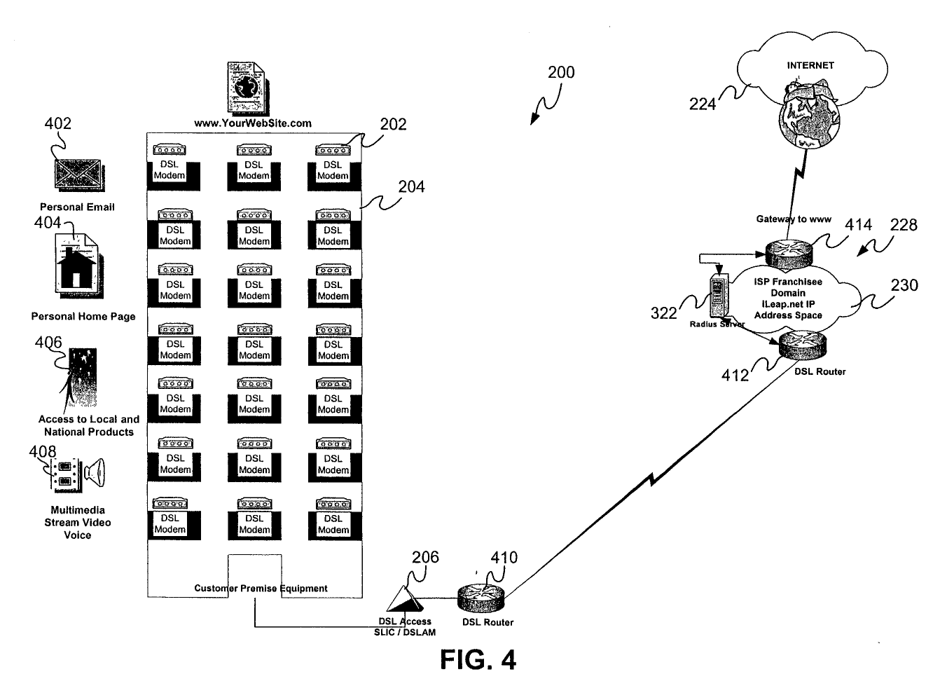

FIG. 4 is a schematic illustration of a subscriber process in the DSL architecture 200 of ISP franchise framework in accordance with an embodiment of the present invention, via a DSL modem, the DSL subscriber 202 (i.e., a user) in the MDU 204 may access data such email 402, web pages 404, 406, and multimedia 408 through the ISP franchise framework. The DSL subscriber's DSL modem 202 is connected to the DSLAM 206 which in turn is connected to at least one router 410 of the local ISP. Via the framework (see FIG. 2), the router 410 is connected to a router of the 412 of the Independent Locally Empowered Access Provider framework 228. The DSL subscriber can then access/receive applications, content, and services 230 from the Independent Locally Empowered Access Provider framework 228 or access/receive information from the Internet 224 from the Internet via a radius server 322 and a router 414 of the Independent Locally Empowered Access Provider framework 228.

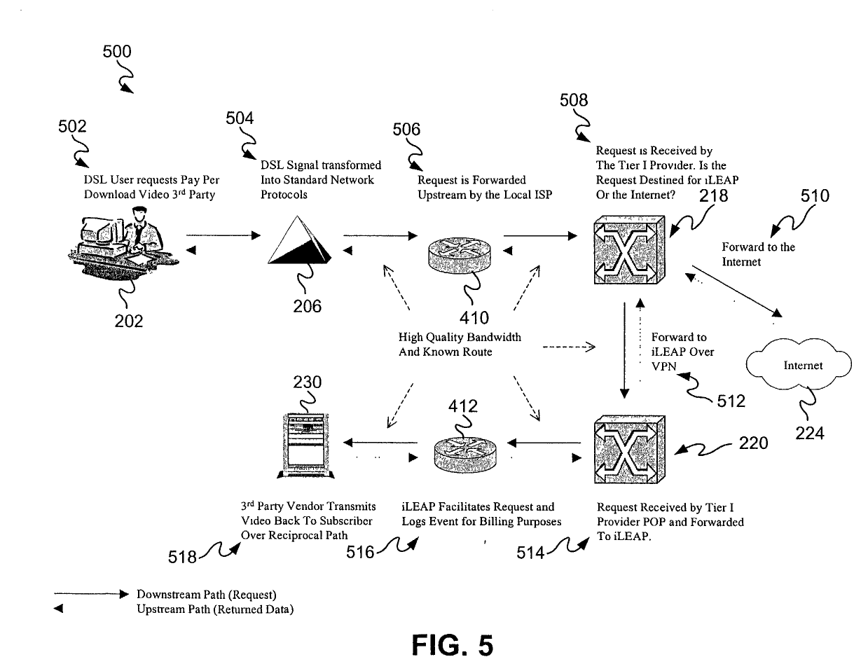

FIG. 5 illustrates a process flow 500 for the subscriber process in ISP franchise framework set forth in FIGS. 2 and 4 in accordance with an embodiment of the present invention where a request path is illustrated by solid lined arrows while a path for returned data is illustrated by dotted lined arrows over a high quality bandwidth and known route. First, a DSL subscriber 202 requests a service such a request to download a video (see 502). The DSL signal is transformed into standard network protocols at the DSLAM 206 (see 504). Next, at 506, the request is forwarded upstream by the local ISP (see router 410). At 508, the request is received by the Tier I Provider 218 where it is determined whether the request is destined for Locally Empowered Access Provider or the Internet. If determined that the destination is the Internet, then the request is forwarded to the Internet 224 at 510. On the other hand, if the request is determined to be destined to the Locally Empowered Access Provider, then the request is forwarded to the Locally Empowered Access Provider over the VPN (see 512). Next, the request is received by the other Tier I Provider POP 220 and forwarded to the Locally Empowered Access Provider (see 514). The Locally Empowered Access Provider (see router 412) then facilitates the request and logs an event for billing purposes (see 516). Finally, the 3rd party vendor 230 transmits video back to the subscriber over the reciprocal path (see 518).

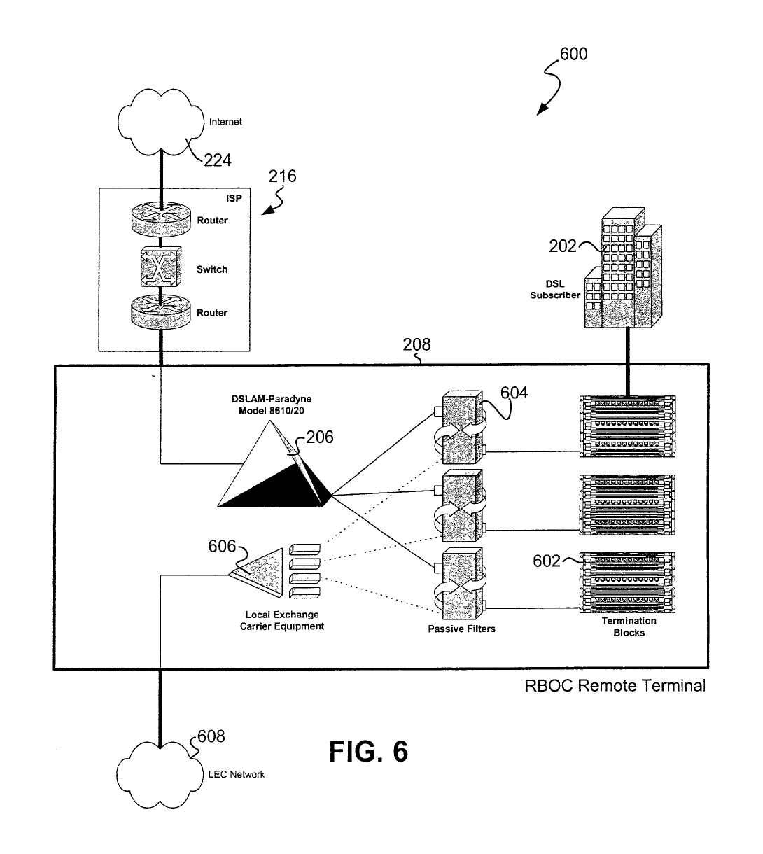

FIG. 6 is a schematic diagram of a Locally Empowered Access Provider/CLEC partnership 600 in accordance with an embodiment of the present invention. In this partnership, the DSL subscriber 202 is coupled to the ISP 216 and Internet 224 via a remote terminal 208 having a plurality of termination blocks 602 each connected to a passive filter 604 which are each connected to a DSLAM 206 (which connects the DSL subscriber to the ISP 216) and local exchange carrier (LEC) equipment 606 which connects the DSL subscriber to a LEC network 608.

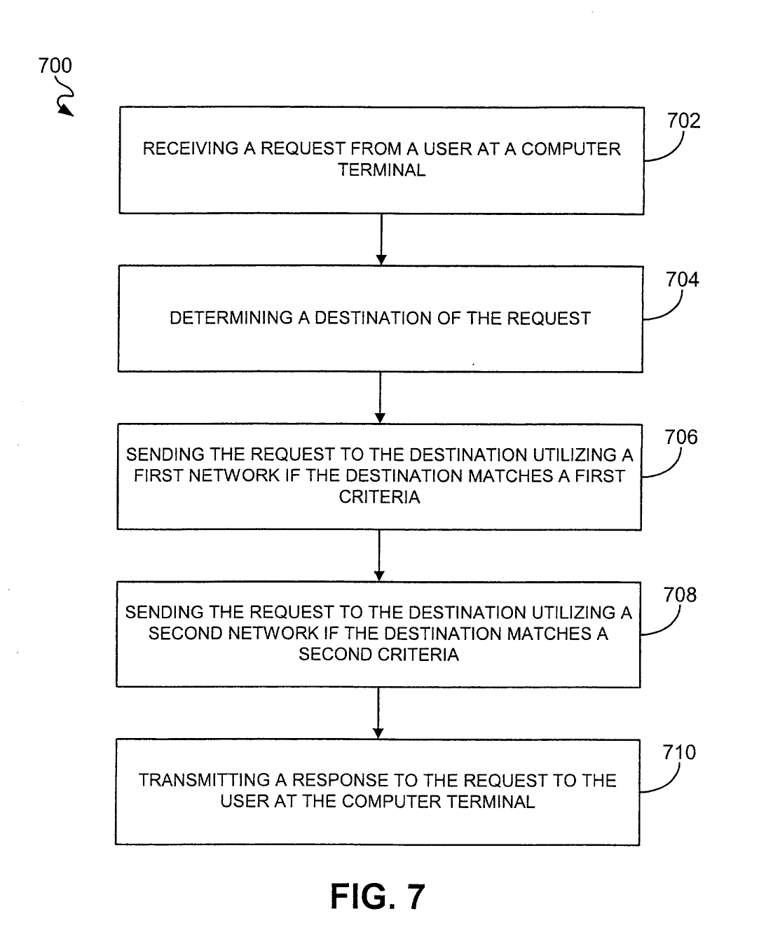

Based on the foregoing, FIG. 7 is a flowchart of a process 700 for delivering guaranteed bandwidth network service in accordance with an embodiment of the present invention. A request is received from a user at a computer terminal in operation 702. A destination of the request is then determined in operation 704. The request is sent to the destination utilizing a first network if the destination matches a first criteria in operation 706. If the destination matches a second criteria, then the request is sent to the destination utilizing a second network in operation 708. A response to the request is subsequently transmitted to the user at the computer terminal in operation 710.

In an aspect of the present invention, the first network may include the Internet, and the first criteria may indicate that the destination includes the Internet. In another aspect, the second network may include a network separate from the Internet, and the second criteria may indicate that the destination includes the second network. In such an aspect, the second network may include a virtual private network (VPN). In a further aspect, the second criteria may indicate that the destination includes a local destination. In an additional aspect, the operations may be carried out utilizing a module positioned within one thousand (1000) feet from the computer terminal. In such an aspect, the module may include a multiplexer. Further, the multiplexer may include a digital subscriber line access multiplexer (DSLAM). In one aspect of the present invention, the network service may include digital subscriber line (DSL) service. With this process, high speed DSL Internet service may be delivered through the framework previously set forth to decouple delivery from the normal distance limitations of DSL and the bandwidth congestion problems normally associated with this kind of service when provided by the established local carriers (LEC's). Through this framework, franchisees may be directly connected both to end customers and to tier-one Internet backbone providers. This may allow the local franchisee to both manage available bandwidth to meet requirements, and to have redundant connections to ensure service in the face of network failures.

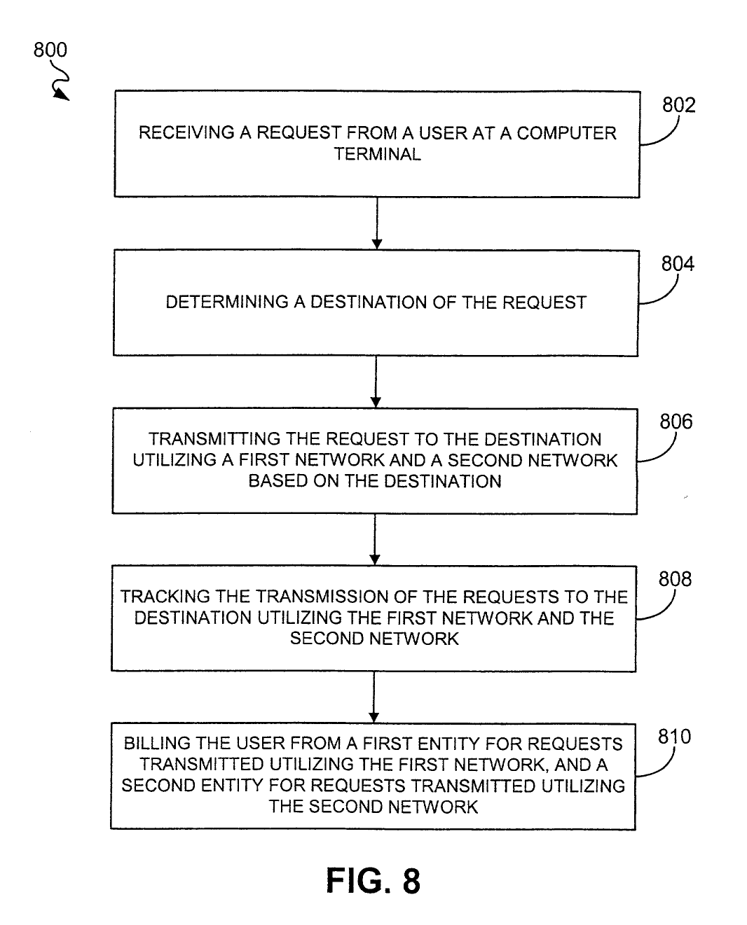

FIG. 8 is a flowchart of a process 800 for billing for guaranteed bandwidth network service in accordance with an embodiment of the present invention. A request is received from a user at a computer terminal in operation 802. A destination of the request is then determined in operation 804. Next, the request is transmitted to the destination utilizing a first network and a second network based on the destination in operation 806. The transmission of the requests to the destination is tracked utilizing the first network and the second network in operation 808. The user is billed from a first entity for requests transmitted utilizing the first network, and a second entity for requests transmitted utilizing the second network in operation 810. Through this process, a franchise network may be established with existing and new local ISP's.

In an aspect of the present invention, the first network may include the Internet. In another aspect, the second network may include a network separate from the Internet. In such an aspect, the second network may include a virtual private network (VPN). In a further aspect, receiving the request, determined the destination, and transmitting the request to the destination may be carried out utilizing a module positioned within one thousand (1000) feet from the computer terminal. In such an aspect, the module may include a multiplexer. In one such aspect, the multiplexer may includes a digital subscriber line access multiplexer (DSLAM). In an additional aspect, the tracking and billing may be carried out utilizing a central module.

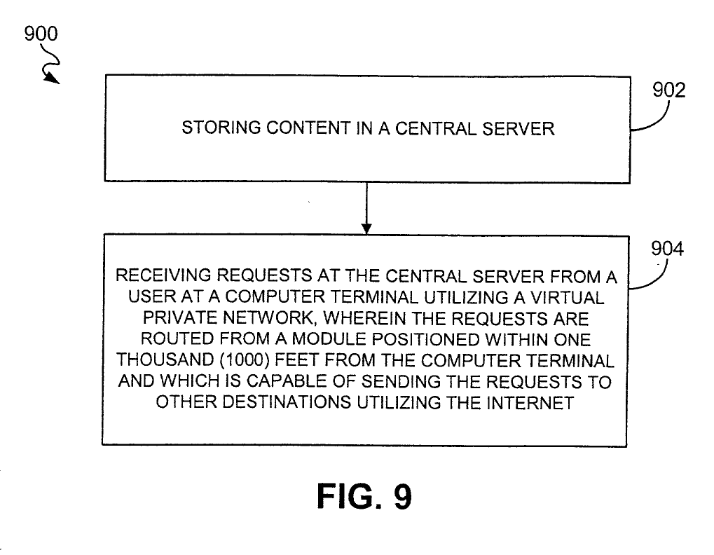

FIG. 9 is a flowchart of a process 900 for delivering content utilizing a guaranteed bandwidth network service in accordance with an embodiment of the present invention. Content is stored in a central server in operation 902. Requests are received at the central server from a user at a computer terminal utilizing a virtual private network in operation 904. The requests are routed from a module positioned within one thousand (1000) feet from the computer terminal and which is capable of sending the requests to other destinations utilizing the Internet. Under this process, the use of a centralized service management system handles customer accounts and provisioning, as well as sourcing various types of information content for end customers. Thus, it may be useful for this service to be highly available with guaranteed bandwidth.

In an aspect of the present invention, the module may include a multiplexer. In such an aspect, the multiplexer may includes a digital subscriber line access multiplexer (DSLAM). In another aspect, the requests received by the central server may be pre-registered. In a further aspect, the requests received by the central server may be tracked for billing purposes. In an additional aspect, the content may include video.

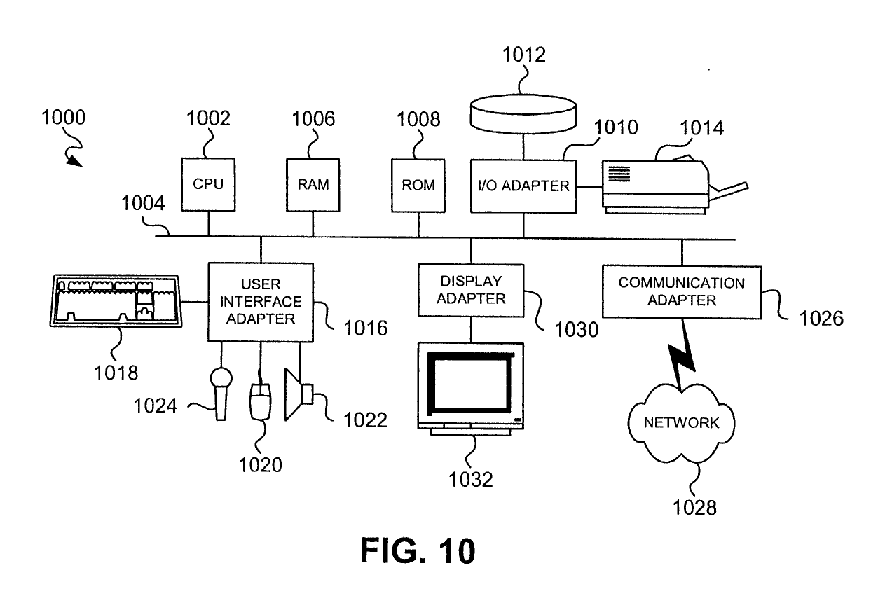

A representative hardware environment capable of carrying out aspects of the present invention is depicted in FIG. 10. In the present description, the various sub-components of each of the components may also be considered components of the system. For example, particular software modules executed on any component of the system may also be considered components of the system. FIG. 10 illustrates an illustrative hardware configuration of a workstation 1000 having a central processing unit 1002, such as a microprocessor, and a number of other units interconnected via a system bus 1004.

The workstation shown in FIG. 10 includes a Random Access Memory (RAM) 1006, Read Only Memory (ROM) 1008, an I/O adapter 1010 for connecting peripheral devices such as, for example, disk storage units 1012 and printers 1014 to the bus 1004, a user interface adapter 1016 for connecting various user interface devices such as, for example, a keyboard 1018, a mouse 1020, a speaker 1022, a microphone 1024, and/or other user interface devices such as a touch screen or a digital camera to the bus 1004, a communication adapter 1026 for connecting the workstation 1000 to a communication network 1028 (e.g., a data processing network) and a display adapter 1030 for connecting the bus 1004 to a display device 1032.

An embodiment of the present invention may be written using traditional methodologies and programming languages, such as C, Pascal, BASIC or Fortran, or may be written using object oriented methodologies and object-oriented programming languages, such as Java, C++, C#, Python or Smalltalk. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a compositionrelationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that can be called when those individual behaviors are desired in the program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes HyperText Markup Language (HTML) to implement documents on the Internet together with a general-purpose secure communication protocol for a transport medium between the client and the server. Information on these products is available in T. Berners-Lee, D. Connoly, “RFC 1866: Hypertext Markup Language-2.0” (November 1995); and R. Fielding, H, Frystyk, T. Berners-Lee, J. Gettys and J. C. Mogul, “Hypertext Transfer Protocol—HTTP/1.1:HTTP Working Group Internet Draft” (May 2, 1996). HTML is a simple data format used to create hypertext documents that are portable from one platform to another. SGML documents are documents with generic semantics that are appropriate for representing information from a wide range of domains and are HTML compatible. HTML has been in use by the World-Wide Web global information initiative since 1990. HTML is an application of ISO Standard 8879; 1986 Information Processing Text and Office Systems; Standard Generalized Markup Language (SGML).

XML (Extensible Markup Language) is a flexible way to create common information formats and share both the format and the data on the World Wide Web, intranets, and elsewhere. For example, computer makers might agree on a standard or common way to describe the information about a computer product (processor speed, memory size, and so forth) and then describe the product information format with XML. Such a standard way of describing data would enable a user to send an intelligent agent (a program) to each computer maker's Web site, gather data, and then make a valid comparison. XML can be used by any individual or group of individuals or companies that wants to share information in a consistent way.

XML, a formal recommendation from the World Wide Web Consortium (W3C), is similar to the language of today's Web pages, the Hypertext Markup Language (HTML). Both XML and HTML contain markup symbols to describe the contents of a page or file. HTML, however, describes the content of a Web page (mainly text and graphic images) only in terms of how it is to be displayed and interacted with. For example, the letter “p” placed within markup tags starts a new paragraph. XML describes the content in terms of what data is being described. For example, the word “phonenum” placed within markup tags could indicate that the data that followed was a phone number. This means that an XML file can be processed purely as data by a program or it can be stored with similar data on another computer or, like an HTML file, that it can be displayed. For example, depending on how the application in the receiving computer wanted to handle the phone number, it could be stored, displayed, or dialed.

XML is “extensible” because, unlike HTML, the markup symbols are unlimited and self-defining. XML is actually a simpler and easier-to-use subset of the Standard Generalized Markup Language (SGML), the standard for how to create a document structure. It is expected that HTML and XML will be used together in many Web applications. XML markup, for example, may appear within an HTML page.

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystems's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to Java is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for Java without undue experimentation to practice the invention.

Transmission Control Protocol/Internet Protocol (TCP/IP) is a basic communication language or protocol of the Internet. It can also be used as a communications protocol in the private networks called intranet and in extranet. When one is set up with direct access to the Internet, his or her computer is provided with a copy of the TCP/IP program just as every other computer that he or she may send messages to or get information from also has a copy of TCP/IP.

TCP/IP comprises a Transmission Control Protocol (TCP) layer and an Internet Protocol (IP) layer. TCP manages the assembling of series of packets from a message or file for transmission of packets over the internet from a source host to a destination host. IP handles the addressing of packets to provide for the delivery of each packet from the source host to the destination host. Host computers on a network, receive packets analyze the addressing of the packet If the host computer is not the destination the host attempts to route the packet by forwarding it to another host that is closer in some sense to the packet's destination. While some packets may be routed differently through a series of interim host computers than others, TCP and IP provides for the packets to be correctly reassembled at the ultimate destination. TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously (note that the TCP layer itself is not stateless as far as any one message is concerned. Its connection remains in place until all packets in a message have been received.).

Many Internet users are familiar with the even higher layer application protocols that use TCP/IP to get to the Internet. These include the World Wide Web's Hypertext Transfer Protocol (HTTP), the File Transfer Protocol (FTP), Telnet which lets one logon to remote computers, and the Simple Mail Transfer Protocol (SMTP). These and other protocols are often packaged together with TCP/IP as a “suite.”

Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX)is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data.

Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPTP) and Microsoft has extended Windows NT_to support it. VPN software is typically installed as part of a company's firewall server.

Based on the foregoing specification, the invention may be implemented using computer programming or engineering techniques including computer software, firmware, hardware or any combination or subset thereof Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for delivering content utilizing a guaranteed bandwidth network service, comprising:
a) storing content in a central server; and
b) receiving requests at the central server from a user at a computer terminal utilizing a virtual private network, wherein the requests are routed from a module positioned within one thousand (1000) feet from the computer terminal and which is capable of sending the requests to other destinations utilizing the Internet.

2. The method of claim 1, wherein the module includes a multiplexer.

3. The method of claim 2, wherein the multiplexer includes a digital subscriber line access multiplexer (DSLAM).

4. The method of claim 1, wherein the requests received by the central server are pre-registered.

5. The method of claim 1, wherein the requests received by the central server are tracked for billing purposes.

6. The method of claim 1, wherein the content includes video.

7. A system for delivering content utilizing a guaranteed bandwidth network service, comprising:
a) logic for storing content in a central server; and
b) logic for receiving requests at the central server from a user at a computer terminal utilizing a virtual private network, wherein the requests are routed from a module positioned within one thousand (1000) feet from the computer terminal and which is capable of sending the requests to other destinations utilizing the Internet.

8. The system of claim 7, wherein the module includes a multiplexer.

9. The system of claim 8, wherein the multiplexer includes a digital subscriber line access multiplexer (DSLAM).

10. The system of claim 7, wherein the requests received by the central server are pre-registered.

11. The system of claim 7, wherein the requests received by the central server are tracked for billing purposes.

12. The system of claim 7, wherein the content includes video.

13. A computer program product for delivering content utilizing a guaranteed bandwidth network service, comprising:
a) computer code for storing content in a central server; and
b) computer code for receiving requests at the central server from a user at a computer terminal utilizing a virtual private network; wherein the requests are routed from a module positioned within one thousand (1000) feet from the computer terminal and which is capable of sending the requests to other destinations utilizing the Internet.

14. The computer program product of claim 13, wherein the module includes a multiplexer.

15. The computer program product of claim 14, wherein the multiplexer includes a digital subscriber line access multiplexer (DSLAM).

16. The computer program product of claim 13, wherein the requests received by the central server are pre-registered.

17. The computer program product of claim 13, wherein the requests received by the central server are tracked for billing purposes.

18. The computer program product of claim 13, wherein the content includes video.
